(19) United States
(12) Patent Application Publication
(10) Pub. No.: US 2019/0279025 A1
(43) Pub. Date: Sep. 12, 2019

(54) IMAGE PROCESSING APPARATUS

(71) Applicants: Kabushiki Kaisha Toshiba, Tokyo (JP); Toshiba Electronic Devices & Storage Corporation, Tokyo (JP)

(72) Inventors: Miki Yamada, Yokohama Kanagawa (JP); Michio Yamashita, Inagi Tokyo (JP); Makoto Oshikiri, Yokohama Kanagawa (JP)

(21) Appl. No.: 16/121,415

(22) Filed: Sep. 4, 2018

(30) Foreign Application Priority Data
Mar. 9, 2018 (JP) 2018-043324

(51) Int. Cl. G06K 9/62; G06K 9/68; G06T 11/60

(52) U.S. Cl. CPC G06K 9/6202; G06K 9/6857; G06K 2209/01; G06K 2209/21; G06T 11/60

(57) ABSTRACT

An image processing apparatus includes an image pyramid generating section, a memory and a matching section. The image pyramid generating section generates an image pyramid including a plurality of layer images of mutually different sizes, from an input image. The memory stores a first dictionary for detecting a first object and a second dictionary for detecting a second object obtained by reducing the first object at a first predetermined reduction ratio. The matching section performs matching between the first dictionary and between the second dictionary, respectively, and a detection frame image within a detection frame configured to move within the layer image.

### CROSS-REFERENCE TO RELATED APPLICATIONS

This application is based upon and claims the benefit of priority from the Japanese Patent Application No. 2018-043324, filed on Mar. 9, 2018; the entire contents of which are incorporated herein by reference.

### FIELD

An embodiment described herein relates generally to an image processing apparatus.

### BACKGROUND

Conventionally, an object detection technique of generating an image pyramid in which images having different resolutions are layered from an inputted image and searching the image pyramid to detect objects of various sizes has been known.

In the object detection technique, an increase in number of layers of an image pyramid for higher precision detection results in an increase in processing cost.

### BRIEF DESCRIPTION OF THE DRAWINGS

FIG. 1 is a block diagram illustrating an example of a configuration of an image processing apparatus according to an embodiment;

FIG. 2 is a diagram for describing detection processing in the image processing apparatus according to the embodiment;

FIG. 3 is a diagram for describing detection processing in the image processing apparatus according to the embodiment;

FIG. 4 is a diagram for describing grouping processing in the image processing apparatus according to the embodiment; and

FIG. 5 is a flowchart for describing an example of a flow of detection processing in the image processing apparatus according to the embodiment.

### DETAILED DESCRIPTION

An image processing apparatus according to an embodiment includes an image pyramid generating section, a memory and a matching section. The image pyramid generating section generates an image pyramid including a plurality of layer images of mutually different sizes, from an input image. The memory stores a first dictionary for detecting a first object and a second dictionary for detecting a second object obtained by reduction of the first object at a first predetermined reduction ratio. The matching section performs matching between the first dictionary and between the second dictionary, respectively, and a detection frame image within a detection frame configured to move within the layer image.

### Embodiment

An embodiment will be described below with reference to the drawings.

### (Configuration)

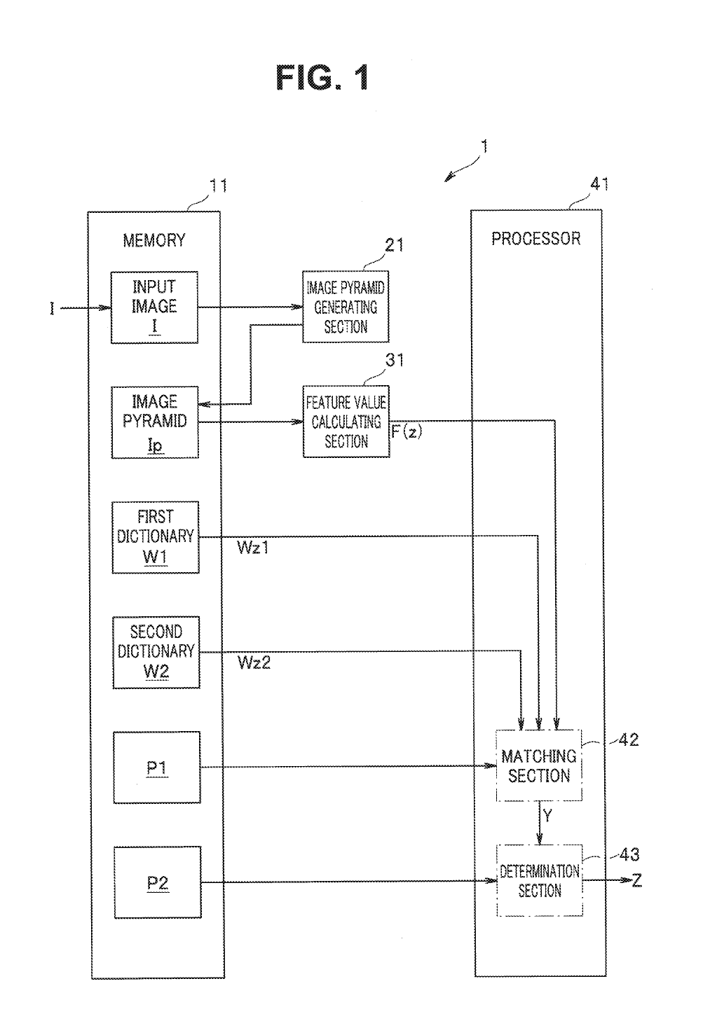

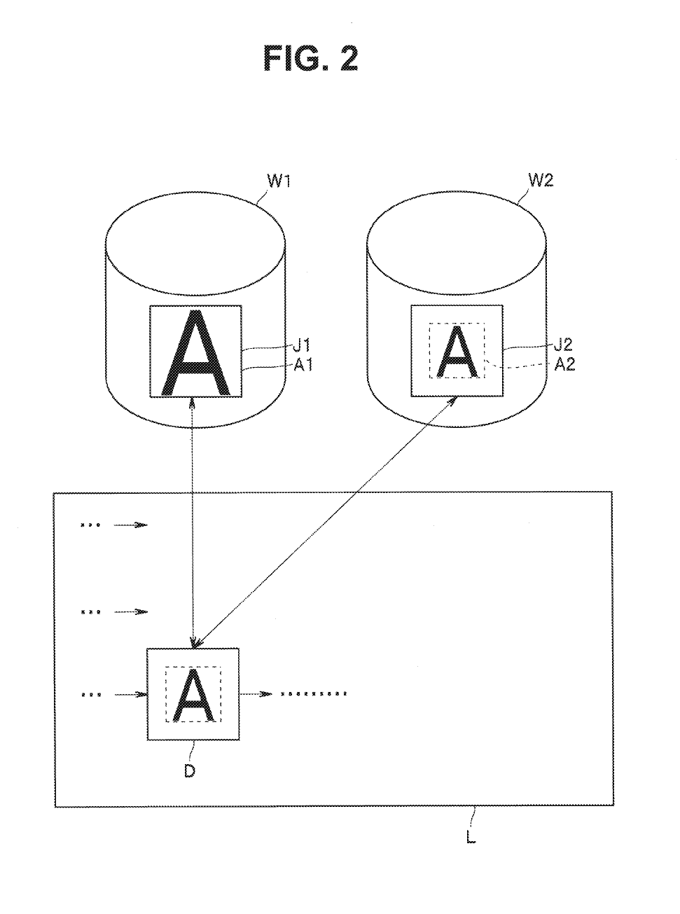

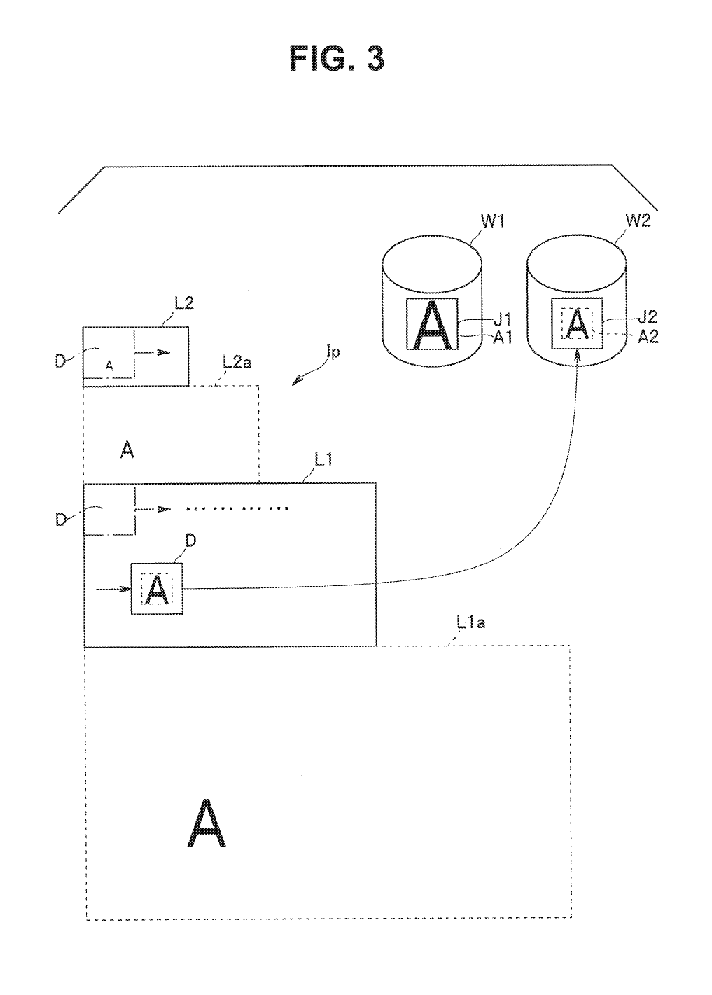

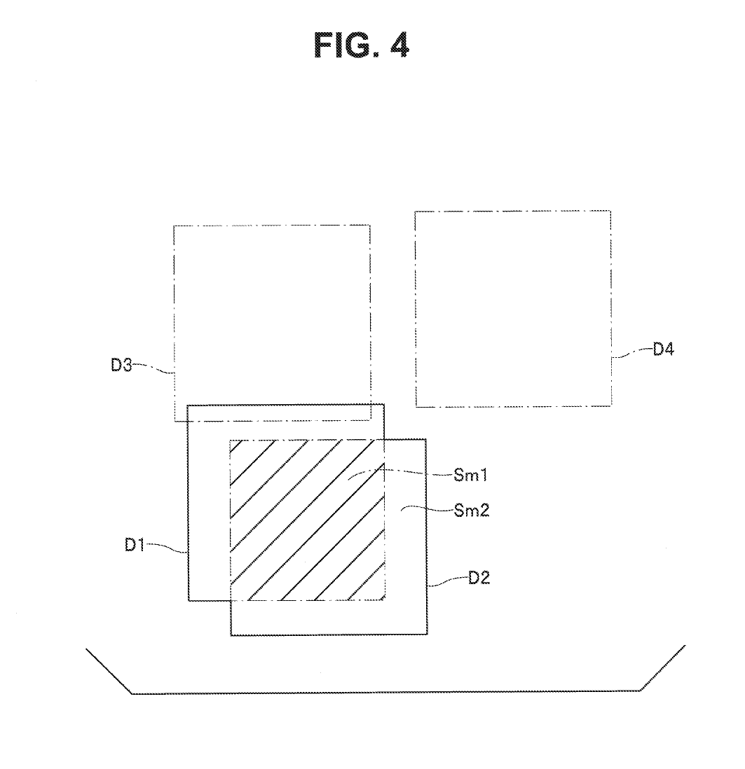

FIG. 1 is a block diagram illustrating an example of a configuration of an image processing apparatus 1 according the embodiment. FIG. 2 is a diagram for describing detection processing in the image processing apparatus 1 according to the embodiment. The letter “A” in FIG. 2 is an example of an object, which is schematically illustrated for description. FIG. 3 is a diagram for describing detection processing in the image processing apparatus 1 according to the embodiment. FIG. 4 is a diagram for describing grouping processing in the image processing apparatus 1 according to the embodiment.

The image processing apparatus 1 includes a memory 11, an image pyramid generating section 21, a feature value calculating section 31 and a processor 41.

The memory 11 includes a storage element such as an SRAM or a DRAM. The memory 11 is connected to the image pyramid generating section 21, the feature value calculating section 31 and the processor 41.

The memory 11 stores various data such as an input image I, an image pyramid Ip, a first dictionary W1 and a second dictionary W2. The memory 11 also stores a program P1 for a matching section 42 and a program P2 for a determination section 43.

The input image I is inputted to the memory 11 from, for example, an external apparatus such as a camera or a storage medium. The input image I can be read from the memory 11 by the image pyramid generating section 21.

The image pyramid Ip is inputted to the memory 11 from the image pyramid generating section 21. The image pyramid Ip can be read from the memory 11 by the feature value calculating section 31.

The first dictionary W1 and the second dictionary W2 are used for detection of objects of mutually different sizes.

A first object is a detection target object having a predetermined size. A second object is a detection target object obtained by reduction of the first object at a first predetermined reduction ratio. Hereinafter, both or either of the first object and the second object may be referred to as “object(s)”.

The first dictionary W1 has a first weight amount Wz1 for detecting the first object. The second dictionary W2 has a second weight amount Wz2 for detecting the second object. Hereinafter, both or either of the first weight amount Wz1 and the second weight amount Wz2 may be referred to as “weight amount(s) Wz”.

The first weight amount Wz1 and the second weight amount Wz2 are the same in structure. For example, if the number of components of the first weight amount Wz1 is n, the number of components of the second weight amount Wz2 is n.

The weight amount Wz is generated in advance by means of predetermined learning processing. As illustrated in FIG. 2, for the first dictionary W1, learning is performed by a first teacher image J1 including an object area A1. For the second dictionary W2, learning is performed using a second teacher image J2 including an object area A2 obtained by reduction of the object area A1 at the first predetermined reduction ratio. The first object can be disposed in the object area A1. The second object can be disposed in the object area A2. In the example in FIG. 2, the first predetermined reduction ratio is 0.6.

In the predetermined learning processing, the weight amounts Wz are generated so that results of respective arithmetic operations using the weight amounts Wz and respective feature values F(z) calculated based on a first teacher image J1 and a second teacher image J2 in which respective objects are disposed become relatively large and results of respective arithmetic operations using the weight amounts Wz and respective feature values F(z) calculated based on a first teacher image J1 and a second teacher image J2 in which no objects are disposed become relatively small.

In other words, the memory 11 stores the first dictionary W1 for detecting the first object and the second dictionary W2 for detecting the second object obtained by reduction of the first object at the first predetermined reduction ratio. The first dictionary W1 is generated based on the first teacher image J1 including the first object, by the predetermined learning processing, and the second dictionary W2 is generated based on the second teacher image J2 including the second object, by the predetermined learning processing. The first dictionary W1 has the first weight amount Wz1 for detecting the first object and the second dictionary W2 has the second weight amount Wz2 for detecting the second object.

As illustrated in FIG. 3, the image pyramid generating section 21 is a circuit configured to generate the image pyramid Ip. More specifically, the image pyramid generating section 21 generates the image pyramid Ip including layer images L based on the input image I read from the memory 11 and outputs the image pyramid Ip to the memory 11. A reduction ratio of a layer image L to another layer image L is set to a second predetermined reduction ratio.

FIG. 3 is an example in which the image pyramid Ip including a first layer image L1 and a second layer image L2 obtained by reduction of the first layer image L1 at the second predetermined reduction ratio is generated from the input image I. In the example in FIG. 3, the second predetermined reduction ratio is 0.36, and the second layer image L2 is reduced to be 0.36 times the first layer image L1 in size. Hereinafter, both or either of the first layer image L1 and the second layer image L2 may be referred to as “layer image(s) L”.

The first predetermined reduction ratio and the second predetermined reduction ratio are empirically or experimentally set so as to obtain a high object detection precision. The first predetermined reduction ratio is set to be a value that is larger than the second predetermined reduction ratio. In the example in FIG. 3, the second predetermined reduction ratio is set to the square of the first predetermined reduction ratio, but the present embodiment is not limited to this example.

In other words, the image pyramid generating section 21 generates the image pyramid Ip having a plurality of layer images L of mutually different sizes, based on the input image I. The image pyramid generating section 21 generates the image pyramid Ip including the first layer image L1, and the second layer image 12 obtained by reduction of the first layer image L1 at the second predetermined reduction ratio that is smaller than the first predetermined reduction ratio.

The feature value calculating section 31 is a circuit configured to calculate a feature value F(z). The feature value calculating section 31 calculates a feature value F(z) from the image pyramid Ip read from the memory 11 and outputs the feature value F(z) to the processor 41.

More specifically, the feature value calculating section 31 scans each of the layer images L included in the image pyramid Ip, via a detection frame D. For example, the feature value calculating section 31 moves the detection frame D to perform scanning in an x direction and upon an end of the scanning in the x direction, moves the detection frame D in a y direction to the next position and then performs scanning in the x direction within the layer image L. Upon an end of the x-y direction scanning, the feature value calculating section 31 performs scanning of a layer image L disposed in a next layer.

The feature value calculating section 31 acquires an image in the detection frame D from a layer image L and calculates a feature value F(z). The feature value F(z) is calculated by, for example, calculating a gradient of each of pixels within the detection frame D and forming a histogram of the gradients as classes. For example, the feature value calculating section 31 performs calculation to determine which of eight luminance gradient directions a1 to a8 each of pixels within the detection frame D has, and calculates a feature value F(z) (where z=a1 to a8) based on frequencies of the luminance gradient directions a1 to a8.

Here, the feature value F(z) is not limited to this example, and may be calculated based on gradient magnitudes of divisional areas within the detection frame D or calculated based on hues of the pixels within the detection frame D, or the pixels within the detection frame D themselves may be used as the feature value F(z) or the feature value F(z) may be calculated by another method. In the predetermined learning processing, learning for the weight amounts Wz is performed based on the method of calculation of the feature value F(z) in the feature value calculating section 31.

The processor 41 includes a processing device such as an MPU. The processor 41 is connected to respective sections in the image processing apparatus 1, and is configured to perform control to the respective sections in the image processing apparatus 1. The processor 41 reads the programs P1, P2 from the memory 11, and executes the program P1 to provide a function of the matching section 42 and executes the program P2 to provide a function of the determination section 43. The processor 41 is connected to an external apparatus and outputs a determination result Z of determination by the determination section 43.

The matching section 42 performs matching between the first dictionary W and between the second dictionary W2, respectively, and a detection frame image within the detection frame D configured to move within a layer image L. More specifically, the matching section 42 performs a predetermined arithmetic operation based on the first weight amount Wz1 and a feature value F(z) to calculate a first likelihood. Also, the matching section 42 performs a predetermined arithmetic operation based on the second weight amount Wz2 and the feature value F(z) to calculate a second likelihood. The matching section 42 outputs a matching result Y including the first likelihood and the second likelihood, a layer direction position, which is a position in a layer direction of the layer image L, and frame coordinates of the detection frame D, the layer direction position and the frame coordinates being associated with the first likelihood and the second likelihood, respectively, to the determination section 43.

The predetermined arithmetic operation is, for example, an arithmetic operation to calculate the inner product of a weight amount Wz(z) and a feature value F(z) as indicated in Equation (1). In Equation (1), Sc is either a first likelihood or a second likelihood.

$$\begin{matrix}Sc = Σ Wz ( z ) \cdot F ( z ) ( where z = 1 to n ) \\ = Wz ( 1 ) \times F ( 1 ) + Wz ( 2 ) \times F ( 2 ) … Wz ( n ) \times F ( n )\end{matrix} \qquad ( 1 )$$

In other words, the matching section 42 performs matching by means of an arithmetic operation using each of the first weight amount Wz1 and the second weight amount W72 and a feature value F(z) calculated from a detection frame image.

The determination section 43 performs determination processing, based on the matching results Y inputted from the matching section 42, and outputs a determination result Z including an object detection count, detection positions, detection sizes and detection scores.

The determination section 43 extracts a detection candidate, at least the first likelihood or the second likelihood of which is equal to or exceeds a predetermined likelihood threshold value. The predetermined likelihood threshold value is empirically or experimentally set based on the first likelihood and the second likelihood, so as to enable detection of an object. If a plurality of detection candidates are extracted, the determination section 43 performs grouping processing based on layer direction positions and frame coordinates associated with the respective detection candidates to group detection candidates determined as the same object to generate a detection candidate group.

As illustrated in FIG. 4, in the grouping processing, the determination section 43 extracts an overlapping detection candidate that fully or partly overlaps a detection candidate from other detection candidates. Subsequently, the determination section 43 calculates an overlap area Sm1 of the overlapping part and a detection candidate area Sm2 defined by the detection candidate and the overlapping detection candidate. Subsequently, if a value of calculation of Sm1/Sm2 is equal to or exceed a predetermined area threshold value, the determination section 43 determines the detection candidate and the overlapping detection candidate as the same object. In the example in FIG. 4, for a detection candidate D1, the determination section 43 extracts overlapping detection candidates D2, D3 from detection candidates D2 to D4 other than the detection candidate D1. Subsequently, the determination section 43 calculates an overlap area Sm1, which is indicated by the hatching in FIG. 4, and a detection candidate area Sm2, which is surrounded by a solid line, and if a value of calculation of Sm1/Sm2 is equal to or exceeds the predetermined area threshold value, determines the detection candidate D1 and the overlapping detection candidate D2 as the same object. An overlapping detection candidate D3 is an example where a value of calculation of Sm1/Sm2 is below the predetermined area threshold value and the detection candidate D1 and the overlapping detection candidate D3 are determined as different objects.

The determination section 43 sums the number of detection candidate groups and the number of detection candidates not grouped to determine the detection count.

The determination section 43 determines the detection positions. A detection position for a detection candidate group is determined according to a center position of frame coordinates associated with a plurality of detection candidates included in the detection candidate group. A detection position for a detection candidate not grouped is determined according to a center position of frame coordinates associated with the detection candidate.

The determination section 43 determines detection sizes for a detection candidate group and a detection candidate not grouped, based on the layer direction position, the first likelihood and the second likelihood. More specifically, the determination section 43 calculates a reduction ratio of a layer image L to an input image I in the layer direction position. Subsequently, the determination section 43 determines detection sizes based on the sizes of the object areas A1, A2 and the reduction ratio. For example, where the object areas A1, A2 have a size of 16×16 pixels and the reduction ratio is 0.5, the determination section 43 multiplies the size of the object area A1, A2 by the reciprocal of the reduction ratio and determines the detection sizes according to 32×32 pixels. For the size of the object area A1, A2, if the first likelihood is equal to or exceeds the second likelihood, the size of the object area A1 is used, and if the first likelihood is below the second likelihood, the size of the object area A2 is used. In other words, if the first likelihood is equal to or exceeds the second likelihood, the determination section 43 determines the detection sizes according to the size of the first object, and if the first likelihood is below the second likelihood, the detection sizes are determined according to the size of the second object.

The determination section 43 determines higher likelihood of the first likelihood and the second likelihood as the detection scores.

Note that the above processing is an example of determination processing in the determination section 43 and is not intended to limit the determination processing. The determination section 43 may determine an object detection count, detection positions, detection sizes and detection scores by means of processing other than the above-described determination processing.

### (Operation)

Next, operation of the image processing apparatus 1 according to the embodiment will be described.

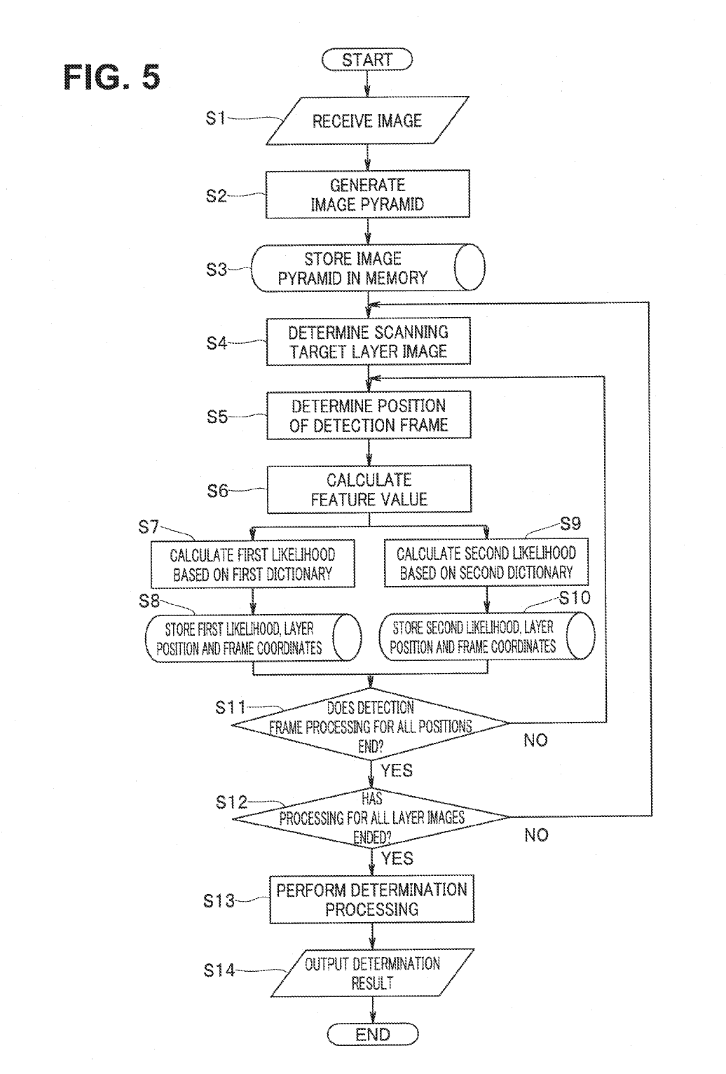

FIG. 5 is a flowchart for describing an example of detection processing in the image processing apparatus 1 according to the embodiment.

The image processing apparatus 1 receives an input image I (S1). The memory 11 stores the input image I inputted. The image pyramid generating section 21 reads the input image I stored in the memory 11 and generates an image pyramid Ip (S2). The image pyramid generating section 21 outputs the image pyramid Ip to the memory 11I. The memory 11 stores the image pyramid Ip (S3).

The feature value calculating section 31 determines a scanning target layer image L (S4). The processing in S4 to S12 is performed repeatedly, and the feature value calculating section 31 determines a scanning target layer image L according to the number of repetitions.

The feature value calculating section 31 determines a position of a detection frame D (S5). The processing in S5 to S11 is performed repeatedly, and the feature value calculating section 31 determines a position of the detection frame D that scans the relevant layer image L, according to the number of repetitions.

The feature value calculating section 31 calculates a feature value F(z) (S6). The feature value calculating section 31 calculates a feature value F(z) based in an image in the detection frame D and outputs the feature value F(z) to the processor 41.

The processor 41 performs processing for the matching section 42. The matching section 42 calculates a first likelihood based on the first dictionary W1 (S7). The matching section 42 outputs a matching result Y including the first likelihood, the layer direction position and the frame coordinates to the memory 11 to store the matching result Y in the memory 11 (S8). The matching section 42 calculates a second likelihood based on the second dictionary W2 (S9). The matching section 42 outputs a matching result Y including the second likelihood, the layer direction position and the frame coordinates to the memory 11 to store the matching result Y in the memory 11 (S10). The processing in S7 and S8 and the processing in S9 and S10 are performed in parallel but may be performed in series.

If processing for the detection frame D for all of positions has not yet ended, the processing returns to S5 (S11: NO). On the other hand, processing for the detection frame D for all of the positions has ended, the processing proceeds to S12 (S11: YES).

If processing for all of layer images L has not yet ended, the processing returns to S4 (S12: NO). On the other hand, if processing for all of the layer images L has ended, the processing proceeds to S13 (S12: YES).

The determination section 43 reads the matching results Y from the memory 11 and performs determination processing (S13). The determination section 43 determines an object detect count, detection positions, detection sizes and detection scores by means of the determination processing. The determination section 43 outputs a determination result Z to an external apparatus (S14).

The processing in S1 to S14 constitutes detection processing in the image processing apparatus 1.

Consequently, in the image processing apparatus 1, a first object and a second object of mutually different sizes are detected from one layer image L, using the first dictionary W1 and the second dictionary W2. In the example in FIG. 3, for example, even if a first layer image L1a is not provided, the second object can be detected in the first layer image L1. Therefore, the image processing apparatus 1 enables omission of first layer images L1a, L2a, which require high processing costs for generation, without a detection precision decrease and thus enables processing cost reduction.

Also, in the image processing apparatus 1, in the first dictionary W1 and the second dictionary W2, respective sizes of objects relative to the detection frame D are different from each other, and thus a search of a current layer image L can be performed as if the search includes a search of another layer image L.

In other words, the image processing apparatus 1 performs two types of likelihood calculations in which respective sizes of objects are different from each other, for a detection frame image extracted from the detection frame D or a feature value F(z) acquired from the detection frame image, enabling provision of an effect of a search corresponding to a search of two layer images L being performed by a search of one layer image L. In other words, the image processing apparatus 1 performs a plurality of likelihood calculations using a plurality of dictionaries at each position of the detection frame D in one search.

Since each layer image L has a large amount of data, processing of one extra layer image L increases in frequency of access to an external memory, resulting in an increase in processing load of image reduction processing and an increase in necessary memory capacity. For example, in order to thoroughly search an image having around 1000 pixels on each side in one search, it is necessary to place a detection frame D at several thousands of positions, extract respective detection frame images and calculate respective feature values F(z), resulting in a processing cost increase. On the other hand, likelihood calculation using a feature value F(z) and the first dictionary W1 and the second dictionary W2 substantially only needs to perform an arithmetic operation to calculate an inner product based on dimensions of the feature value F(z), and thus, a processing cost increase when one extra likelihood calculation is performed is not so large.

According to the embodiment, the image processing apparatus 1 enables more processing reduction without a detection precision decrease and can detect an object from an input image I.

In the embodiment, the image processing apparatus 1 includes the first dictionary W1 and the second dictionary W2, but the embodiment is not limited to this case, and the image processing apparatus 1 may include a third dictionary, and may include more dictionaries.

Although in the embodiment, the functions of the respective sections are provided by the configurations of the circuits and the programs P1, P2 executed by the processor 41, the configurations of the circuits may be provided by programs executed by the processor 41 or the functions provided by the programs P1. P2 may be provided by circuits.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image pyramid generating section configured to generate an image pyramid including a plurality of layer images of mutually different sizes, from an input image;
a memory configured to store a first dictionary for detecting a first object and a second dictionary for detecting a second object obtained by reducing the first object at a first predetermined reduction ratio; and
a matching section configured to perform matching between the first dictionary and between the second dictionary, respectively, and a detection frame image within a detection frame configured to move within the layer image.

2. The image processing apparatus according to claim 1, wherein:
the first dictionary is generated by predetermined learning processing based on a first teacher image including the first object; and
the second dictionary is generated by the predetermined learning processing based on a second teacher image including the second object.

3. The image processing apparatus according to claim 1, wherein:
the first dictionary has a first weight amount for detecting the first object;
the second dictionary includes a second weight amount for detecting the second object; and
the matching section performs the matching by an arithmetic operation using each of the first weight amount and the second weight amount, and a feature value calculated from the detection frame image.

4. The image processing apparatus according to claim 1, wherein the image pyramid generating section generates the image pyramid including a first layer image, and a second layer image obtained by reducing the first layer image at a second predetermined reduction ratio that is smaller than the first predetermined reduction ratio.
